(19) United States
(12) Patent Application Publication
(10) Pub. No.: US 2018/0008917 A1
(43) Pub. Date: Jan. 11, 2018

(54) WATER FILTER ASSEMBLY AND REFRIGERATION APPLIANCE EQUIPPED THEREWITH

(71) Applicant: BSH HAUSGERAETE GMBH, Muenchen (DE)

(72) Inventors: EUGEN GAPLIKOW, BUBESHEIM (DE); KARL-FRIEDRICH LAIBLE, LANGENAU (DE)

(21) Appl. No.: 15/644,872

(22) Filed: Jul. 10, 2017

(30) Foreign Application Priority Data
Jul. 8, 2016 (DE) 10 2016 212 531.1

(51) Int. Cl. B01D 35/153; B01D 35/30; F25D 23/12

(52) U.S. Cl. CPC B01D 35/153; F25D 23/126; B01D 35/306; B01D 2201/302; F25D 2323/121

(57) ABSTRACT

A water filter assembly for a refrigeration appliance contains an inlet connection, a filter head, on which a water filter can be mounted, a non-return valve and an outlet connection. The non-return valve is connected to the water filter by way of a hose. The hose can be attached to a connection of the filter head which is already available to feed or drain water, without adjustments to the filter head being required for this purpose.

### CROSS-REFERENCE TO RELATED APPLICATION

This application claims the priority, under 35 U.S.C. §119, of German application DE 10 2016 212 531.1, filed Jul. 8, 2016; the prior application is herewith incorporated by reference in its entirety.

### BACKGROUND OF THE INVENTION

### Field of the Invention

The present invention relates to a water filter assembly for a refrigeration appliance, in particular a domestic refrigeration appliance, such as a refrigerator or a fridge-freezer which is connected to a water supply network for supplying a cold water dispenser integrated in the refrigeration appliance, an ice maker or such like.

Such refrigeration appliances must be protected against the back-flow of water out of the appliance into the supply network by a non-return valve.

Published, non-prosecuted South Korean patent application KR 10 2009 007 7392 A discloses a water filter assembly for a refrigeration appliance, in which a non-return valve is integrated in a filter head in which a filter cartridge is releasably fixed. Since the filter head has to have apertures both for the fresh water to access the filter cartridge and also to drain the filtered water and means for fixing the filter cartridge, it has a complicated design and is correspondingly costly to manufacture, and the integration of the non-return valve necessitates expensive changes to the tools used to manufacture the filter head. If additional space required for the non-return valve cannot be provided in the case of a filter head with a compact structure without changing the external design of the filter head, even consequential changes to the housing of a refrigeration appliance in which the filter head is installed may be necessary.

### SUMMARY OF THE INVENTION

The object of the present invention is to create a water filter assembly with an integrated non-return valve, which can be realized in a cost-effective manner and the installation of which in an existing refrigeration appliance housing requires no or at the most minimal adjustments to the housing.

The object is achieved on the one hand by the non-return valve being connected to the filter head by way of a hose in the case of a water filter assembly with an inlet connection, a filter head, on which a water filter can be mounted, a non-return valve and an outlet connection.

The hose can be attached to a connection of the filter head which is already available to feed or drain water, without adjustments to the filter head being required for this purpose; an existing filter head can therefore be further used unmodified in the inventive water filter assembly. The hose has the freedom of positioning the non-return valve at a point in the refrigeration appliance at which its space requirement can be freed up relatively easily and without the need to adjust components which are complicated and expensive to manufacture.

In principle the non-return valve could be inserted into the hose at any point; one end of the hose is however preferably provided at the point selected for the non-return valve and at this end of the hose a coupling element for connecting the hose to a subsequent line which does not form part of the assembly is provided; the non-return valve is then easy to mount in a through hole in the coupling element by insertion from one open end.

The water filter assembly can be supplied pre-assembled with an inserted non-return valve for refrigeration appliance manufacture, since the filter head and non-return valve are subsequently installed together, one assembly step can be saved when assembling the inventive refrigeration appliance.

The coupling element preferably forms the inlet connection of the assembly, therefore the non-return valve can also separate the filter from the supply network.

In a first direction, the non-return valve can be secured in the through hole by a blocking ring supported in a groove of the through hole; in particular to prevent the non-return valve from falling out of the through hole before installing the water filter assembly in a refrigeration appliance.

The first direction is preferably opposite to the flow direction of the water so that the blocking ring does not have to withstand the water pressure.

To secure the non-return valve from falling out prior to installation of the water filter assembly, it may also be sufficient if the non-return valve is held or clamped in the through hole in a frictionally engaged manner.

In a second direction, the non-return valve is secured in the through hole preferably by narrowing the through hole. Such a safety catch can reliably hold the non-return valve in place also against the water pressure.

The subject matter of the invention is also a refrigeration appliance, in particular a domestic refrigeration appliance, with a water filter assembly as described above.

With such a refrigeration appliance, the inlet connection of the water filter assembly can be accessible from the outside of the refrigeration appliance, in order to be directly connected to the water supply network of a building.

Alternatively the inlet connection of the water filter assembly can be connected to an outer inlet connection of the refrigeration appliance by way of a supply line fixed to the appliance, the non-return valve can then be secured in the through hole against the flow direction of the water by a coupling at the downstream end of the supply line fixed to the appliance.

Other features which are considered as characteristic for the invention are set forth in the appended claims.

Although the invention is illustrated and described herein as embodied in a water filter assembly and a refrigeration appliance equipped therewith, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view of a water filter assembly according to the invention;

FIG. 2 is a longitudinal sectional view through a coupling element of the water filter assembly;

FIG. 3 is a schematic vertical sectional view through a carcass or body of a refrigeration appliance;

FIG. 4 is an alternative sectional view through the carcass of the refrigeration appliance;

FIG. 5 is a longitudinal sectional view through the coupling element connected to a line of the refrigeration appliance which is fixed thereto;

FIG. 6 is a longitudinal sectional view, which is similar to FIG. 2, according to a second embodiment of the invention; and

FIG. 7 is a longitudinal sectional view, which is similar to FIG. 2, according to a third embodiment.

### DETAILED DESCRIPTION OF THE INVENTION

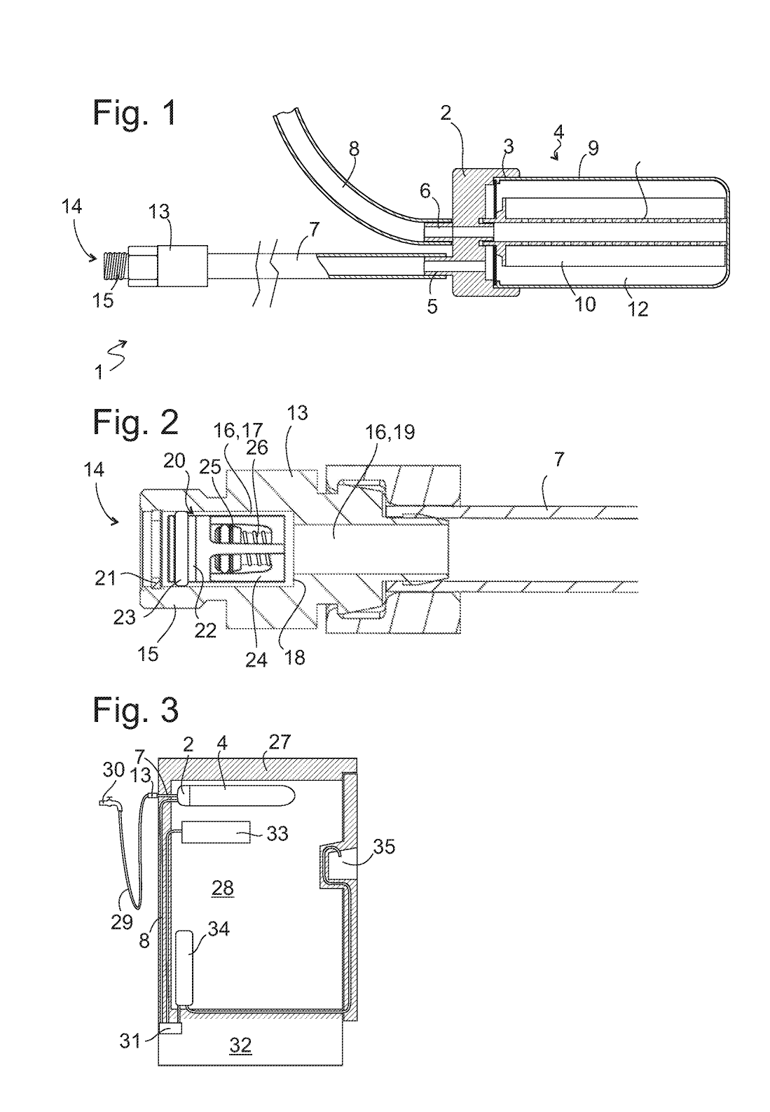

Referring now to the figures of the drawings in detail and first, particularly to FIG. 1 thereof, there is shown a water filter assembly for installation in a refrigeration appliance. A filter head 2 has a supporting molding 3 on one side, in which a water filter 4 is screwed or is fixed in a releasable and water tight manner by a bayonet coupling, and two connecting studs 5, 6, to which hoses 7, 8 are fastened, on the opposing side. The water filter 4 has a cup-shaped housing 9, on the longitudinal axis of which a repeatedly perforated tube 11 surrounded by a porous filter element 10 extends flush with the connecting stud 6. The hose 8 is connected to the interior of the pipe 11 by way of the connecting stud 6, the hose 7 by way of the connecting stud 5 with a clearance 12 which annularly surrounds the filter element 10 in the housing 9. A coupling element 13 on the end of the hose 7 facing away from the filter head 2 forms an inlet connection 14 of the filter assembly. A screw thread 15 at the end of the coupling element 13 facing away from the hose 7 is provided in order to screw together with a line supplying water.

FIG. 2 shows a longitudinal section through the coupling element 13. The coupling element 13 has a through hole 16 with a wide section 17 which opens toward the end of the coupling element facing away from the hose 7 and a narrow section 19 which is separated from this by a narrowing 18 and engages in the hose 7.

A non-return valve 20 is inserted into the wide section 17 from the open end and is secured by a blocking ring 21 which engages in a circumferential groove on the wall of the wide section 17. The non-return valve 20 in the water filter assembly is already secured in a non-volatile manner by the blocking ring 21 before its installation in a refrigeration appliance; the water filter assembly is therefore well suited to being supplied completely pre-assembled and for the refrigeration appliance manufacture at a location which is remote from the manufacture of the refrigeration appliance, particularly in the case of an outside supplier.

The non-return valve 20 has an annular valve seat 22 with a circumferential groove. A sealing ring 23 accommodated in the groove blocks a gap between the valve seat 22 and the surrounding wall of the coupling element 13. A closing element 25 and a spring 26 which forces the closing element 25 against the valve seat 22 are accommodated in a basket 24 which projects from the valve seat 22 in the through direction of the water.

FIG. 3 shows a schematic section through a household refrigeration appliance equipped with the water filter assembly in FIG. 1 according to a first embodiment of the invention. Here the hose 7 is placed fixedly in the appliance and extends through a thermal insulation layer 27 of the appliance between the coupling element 13 which is accessible on the outside of a rear wall of the appliance on the one hand and the filter head 2 and the water filter 4 on the other hand, which are arranged in a cooled interior 28 of the appliance which is enclosed by the thermal insulation layer 27. The coupling element 13 is connected to the water supply network 30 by way of a hose 29 which runs outside of the appliance.

The hose 8 runs from the filter head 2 through the thermal insulation layer 27 to a distributor valve assembly 31 in the machine compartment 32 of the appliance. Lines emanating therefrom lead to an ice maker 33 and via a cooled storage tank 34, to a water dispenser 35.

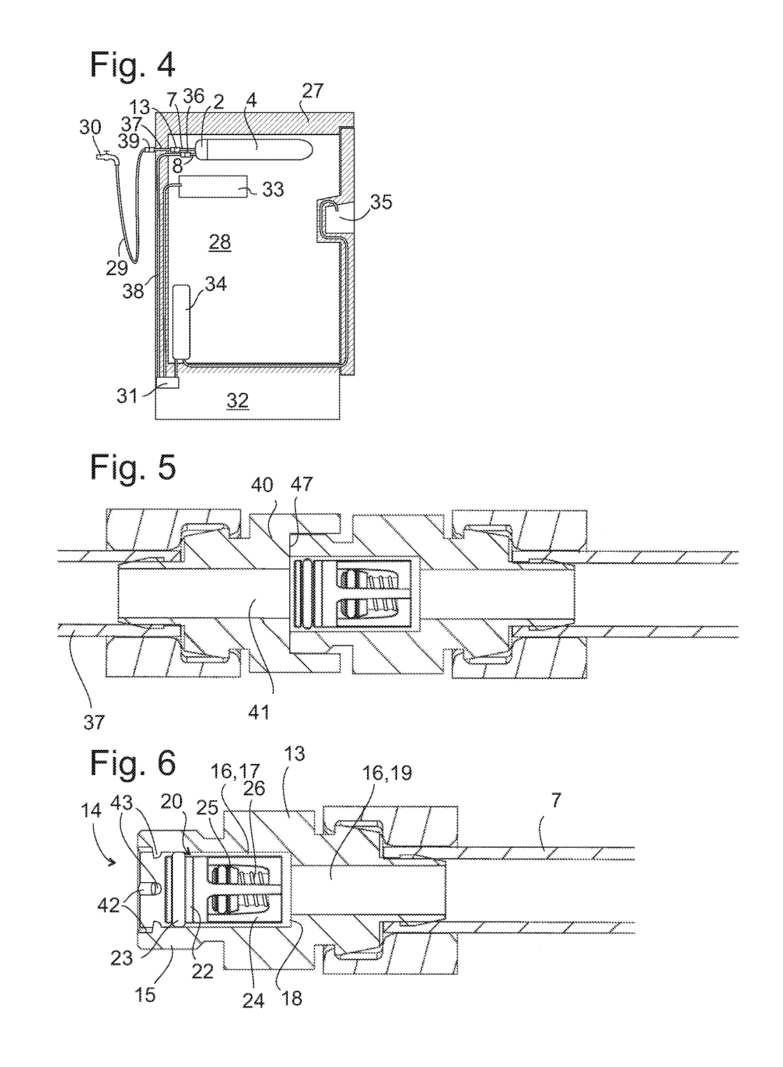

In the embodiment in FIG. 4, the hoses 7, 8 of the water filter assembly only extend up to coupling elements 13, 36 in the cooled interior 28 of the appliance and are connected to lines 37, 38 running fixedly in the walls thereof, of which the one 37 leads to a coupling 39 accessible on the rear side of the appliance and connected to the water supply network 30 and the other 38 to the distributor valve assembly 31. With this embodiment, installation of the water filter assembly can be postponed until the housing of the appliance including the thermal insulation layer 27 is completely assembled.

In this embodiment the blocking ring 21 may not be necessary and its object of immobilizing the non-return valve 20 against the flow direction of the water, as shown in FIG. 5, can be taken over by a coupling element 40 of the line 37 which complements the coupling element 13 and is screw-connected here, the through hole 41 of which is narrower than the diameter of the non-return valve 20. In order to secure the non-return valve 20 in the coupling element 13 until installation of the water filter assembly, a frictional connection of the sealing ring 23 in the through hole 16 or another type may be sufficient to clamp the non-return valve 20 in the through hole 16.

FIG. 6 shows a longitudinal section through a coupling element 13′ according to a second embodiment of the invention. The outer design of the coupling element 13′ is identical to the coupling element 13 in FIG. 2 and in both figures the same reference characters refer to identical components. The groove and the blocking ring 21 at the open end of the through hole 16 are not required here; instead, the non-return valve 20 is secured against leaking through the open end, by, after inserting the non-return valve 20, a tool having been pressed into the open end, said tool molding axial grooves 42 in the wall of the wide section 17 and the material displaced in the process having been pushed together to form projections 43 which obstruct the passage of the non-return valve 20.

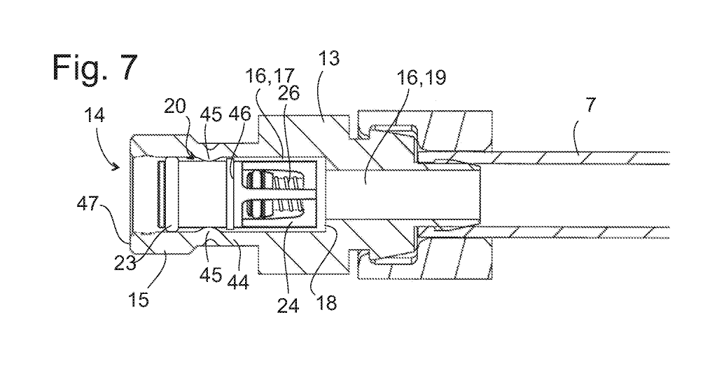

FIG. 7 shows a longitudinal section through a coupling element 13″ according to a second embodiment of the invention. In turn the same reference characters refer to components which are identical to those of the embodiments described above.

The distance between the screw thread 15 and the narrowing 18 is enlarged here in order to create space for a thin-walled pipe section 44. After inserting the non-return valve 20 this pipe section 44 is compressed locally in order to mold projections 45 engaging in the wide section 17 of the through hole 16 which secure the non-return valve 20 in a form-fit manner. The non-return valve 20 can be axially extended as shown in the FIG. 7 so that the projections 45 on the circumference of the non-return valve 20 can engage between the sealing ring 23 and a second projecting ring 46, worth considering however is also to make the pipe section 44 so long that the projections 45 such as the projections 43 in FIG. 6 engage between the non-return valve 20 and the open end into the through hole 16. The coupling element 13″ is however less compact than the coupling elements 13 or 13′, but is advantageous compared with the coupling element 13′ in that there is no risk of negatively affecting a sealing surface 47 which extends around the open end by molding the projections 45.

The following is a summary list of reference numerals and the corresponding structure used in the above description of the invention:
1 Water filter assembly
2 Filter head
3 Supporting molding
4 Water filter
5 Connecting stud
6 Connecting stud
7 Hose
8 Hose
9 Housing
10 Filter element
11 Pipe
12 Clearance
13 Coupling element
14 Inlet connection
15 Screw thread
16 Through hole
17 Wide section
18 Narrowing
19 Narrow section
20 Non-return valve
21 Blocking ring
22 Valve seat
23 Sealing ring
24 Basket
25 Closing element
26 Spring
27 Thermal insulation layer
28 Interior
29 Hose
30 Water supply network
31 Distributor valve assembly
32 Machine compartment
33 Ice maker
34 Storage tank
35 Water dispenser
36 Coupling element
37 Line
38 Line
39 Coupling
40 Coupling element
41 Through hole
42 Groove
43 Projection
44 Pipe section
45 Projection
46 Ring
47 Sealing surface

1. A water filter assembly for a refrigeration appliance, the water filter assembly comprising:
an inlet connection;
a water filter;
a filter head on which said water filter is mounted;
a hose;
a non-return valve connected to said water filter by way of said hose; and
an outlet connection.

2. The water filter assembly according to claim 1, further comprising a coupling element having a through hole formed therein, said non-return valve is introduced into said through hole of said coupling element at an end of said hose.

3. The water filter assembly according to claim 2, wherein said coupling element forms said inlet connection.

4. The water filter assembly according to claim 2, wherein said non-return valve is secured in said though hole in a form-fit manner.

5. The water filter according to claim 2, wherein said coupling element has a blocking ring and said non-return valve is secured in said through hole in a first direction by said blocking ring which is supported in a groove of said through hole.

6. The water filter assembly according to claim 5, wherein the first direction opposes a flow direction of water.

7. The water filter assembly according to claim 2, wherein said non-return valve is secured by a deformation of said coupling element.

8. The water filter assembly according to claim 3, wherein said non-return valve is held or clamped in said through hole in a frictionally engaged manner.

9. The water filter assembly according to claim 2, wherein said non-return valve is secured in said through hole in a second direction by a narrowing of said through hole.

10. A refrigeration appliance, comprising:
a water filter assembly, containing:
an inlet connection;
a water filter;
a filter head on which said water filter being mounted;
a hose;
a non-return valve connected to said water filter by way of said hose; and
an outlet connection.

11. The refrigeration appliance according to claim 10, wherein said inlet connection of said water filter assembly is accessible on an outside of the refrigeration appliance.

12. The refrigeration appliance according to claim 10,
further comprising an outer inlet connection;
further comprising a line;
further comprising a coupling element;
wherein said inlet connection of said water filter assembly is connected to said outer inlet connection by way of said line fixed in the refrigeration appliance; and
wherein said non-return valve disposed in said through hole is secured against a flow direction of water by said coupling element disposed downstream on said line.
